(19) United States
(12) Patent Application Publication
(10) Pub. No.: US 2004/0196263 A1
(43) Pub. Date: Oct. 7, 2004

(54) Mouse

(75) Inventors: Hiroaki Akiyama, Osaka (JP); Tsuyoshi Watanabe, Osaka (JP); Satoshi Nakagawa, Tokyo (JP)

Correspondence Address: BANNER & WITCOFF, 1001 G STREET N W, SUITE 1100, WASHINGTON, DC, 20001, US

(73) Assignee: Kokuyo Co., Ltd., Osaka (JP)

(21) Appl. No.: 10/651,086

(22) Filed: Aug. 29, 2003

(30) Foreign Application Priority Data
Jun. 3, 2002 (JP) P2002-162212

(51) Int. Cl. G09G 5/08

(52) U.S. Cl. 345/163

(57) ABSTRACT

A mouse M that is used as a pointing device for an information processing unit such as a personal computer comprises a body 1 having at least buttons 11, 12 as an input operating portion, a traveling direction detecting portion 3 that locates at a bottom end portion and detects a direction of traveling and a hand placing portion 2 on which an operator can put his or her hand and is so arranged that the operator can move the mouse M with keeping the hand put on the hand placing portion 2 in order to prevent the hand from rubbing against a top plate of a desk due to an operation of the mouse M.

### FIELD OF THE INVENTION

This invention relates to a mouse used as a pointing device for an information processing unit such as a personal computer.

### BACKGROUND OF THE INVENTION

Conventionally a mouse used as a pointing device for a personal computer is a general semiellipse in a side view and used with making its bottom face contact with an upper face of a top plate.

However, in order to use a mouse having the above shape, an operator usually grips the mouse lightly and moves the mouse with taking a posture in which each of an outer side of a wrist and a pinkie and an outer side of a thumb of the operator touch a top plate and the wrist pushes against the top plate. If the mouse of the above shape is used every day for a long time, each of the outer side of the wrist, the pinkie and the thumb is rubbed against the top plate for a long time. As a result, the rubbed portion might get callused. In addition, the posture in which the wrist pushes against the top plate might cause tendovaginitis due to a load on the wrist.

### SUMMARY OF THE INVENTION

The present claimed invention is to solve the above-mentioned problems and discloses an arrangement of a mouse that can be operated without rubbing the wrist of the operator against the top plate and without applying unnecessary load on the wrist.

A mouse in accordance with the present claimed invention is used as a pointing device for an information processing unit such as a personal computer, comprises a body having at least an input operating portion, a traveling direction detecting portion that detects a direction of traveling and a hand placing portion on which an operator can put his or her hand and is characterized by that the operator can move the mouse with keeping the hand put on the hand placing portion.

In accordance with the arrangement, since the mouse can be traveled with keeping the hand put on the hand placing portion, it is possible to prevent the hand from rubbing against the top plate, thereby to prevent getting callused. In addition, since the hand placing portion is so arranged to absorb a load on the wrist, it is possible to prevent tendovaginitis. Further, the mouse can be moved without gripping the mouse, which makes it possible for a hand handicapped person to operate the mouse with just placing his or her hand on the hand placing portion.

As a concrete embodiment of the mouse represented is the hand placing portion is in a shape of a sheet.

In order to make it easy to use the mouse irrespective of a posture of operating the mouse, the hand placing portion may have such an arrangement that at least a hand placing face as a face which the hand touches is made of a soft material. With this arrangement, the hand placing portion transforms itself by following a posture of the operator handling the mouse and supports the hand with the hand placing face irrespective of a posture of the operator handling the mouse. In addition, the hand placing portion absorbs a load on the wrist, thereby to effectively prevent tendovaginitis.

In order to make the body of the mouse easy to grasp, a front end portion of the body may be in a tapered shape toward the forward. With this shape, it is possible to put a finger of the operator on the button without stretching the finger by force.

In order to make the body of the mouse easy to grasp, the input operating portion may have a button and further a space into which the operator can insert his or her finger may be arranged under a front portion of the body. With this arrangement, a size of the body can be so made that a person with a small hand can operate the mouse with keeping his or her hand put on the button with ease and that a person with a big hand can operate the mouse with keeping his or her finger put on the button and an extra portion of the finger put into the space, which makes it possible to operate the mouse comfortably irrespective of a size of the hand of the operator.

Further, if the button can be pushed with a pulling movement of the finger, it is possible to push the button with keeping the finger put on the button and the extra portion of the finger put into the space without replacing the finger. As a result, the mouse can be operated with ease irrespective of a size of a hand.

As a concrete embodiment of the mouse represented is that the body is arranged to stand from the hand placing portion, a projecting portion is arranged to project forward on an upper portion of the body, the button is arranged at a distal end portion of the projecting portion and the space is arranged under the projecting portion.

In order to make the mouse of the above-arrangement easy to move and to protect the traveling direction detecting portion from dust, a sliding portion made of a skiddy material may be arranged to surround the traveling direction detecting portion.

In the present claimed invention “forward” indicates a direction heading toward a fingertip of an operator who grips the mouse.

As mentioned above, since the mouse of the present claimed invention is provided with the hand placing portion and so arranged that the mouse is moved with the hand placed on the hand placing portion, the mouse can be operated with taking a more natural posture and it is possible to avoid the hand or the wrist from rubbing against a top plate of a desk, thereby to avoid getting callus and tendovaginitis.

### BRIEF DESCRIPTION OF THE DRAWINGS

FIG. 1 is a perspective view of a mouse in accordance with one embodiment of the present claimed invention.

FIG. 2 is a plane view of the mouse in accordance with the embodiment.

FIG. 3 is a side view of the mouse in accordance with the embodiment.

FIG. 4 is a front view of the mouse in accordance with the embodiment.

FIG. 5 is a back view of the mouse in accordance with the embodiment.

FIG. 6 is a bottom view of the mouse in accordance with the embodiment.

FIG. 7 is a longitudinally cross-sectional view showing a state of a hand placing portion in FIG. 4.

### DETAILED DESCRIPTION OF THE PREFERRED EMBODIMENTS

An embodiment of the present claimed invention will be described in detail with reference to the accompanying drawings.

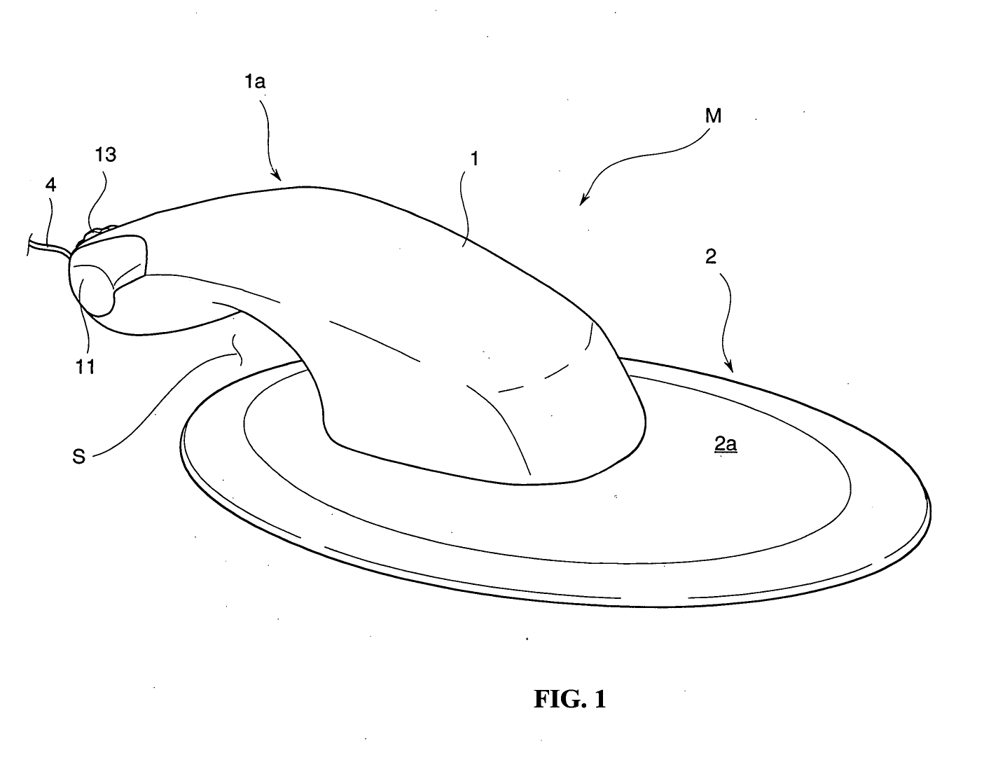

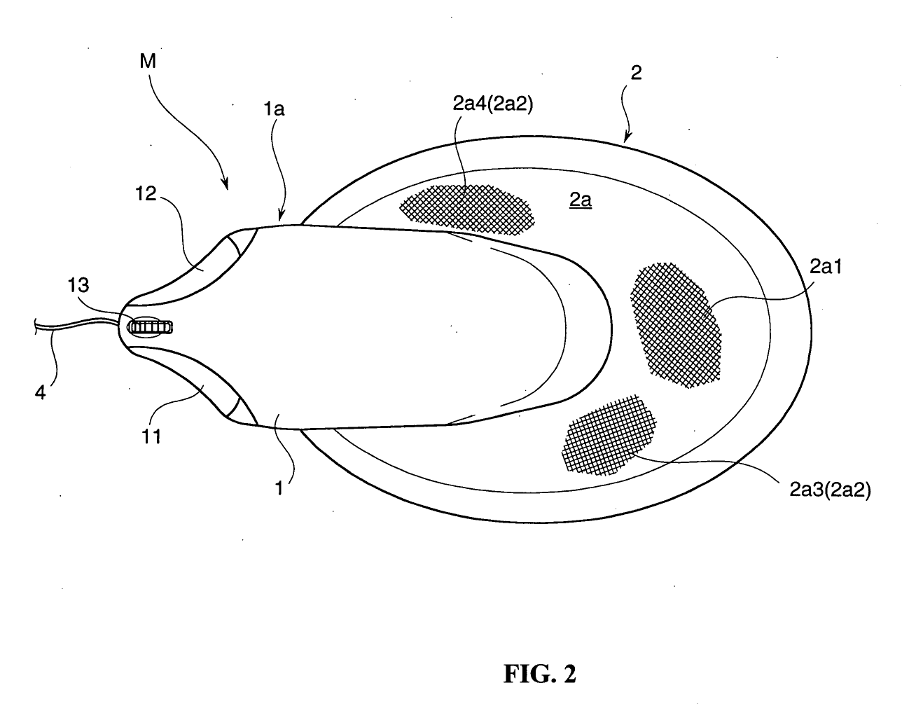

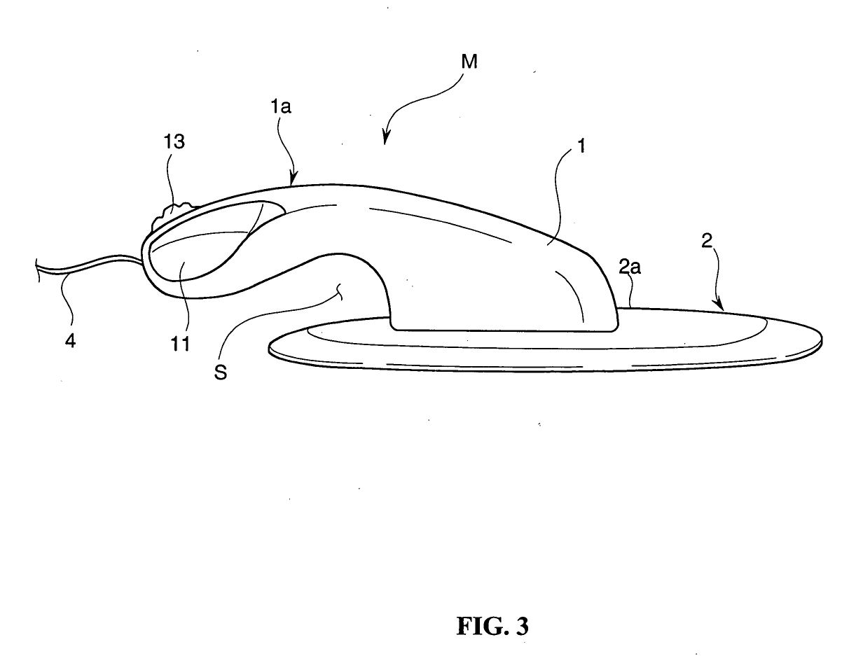

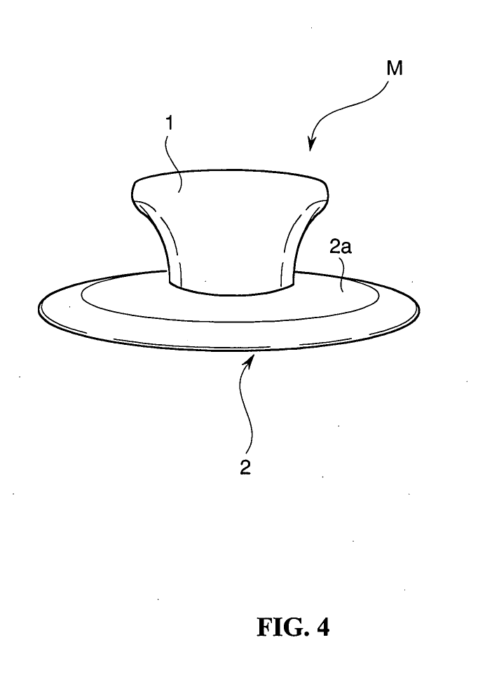

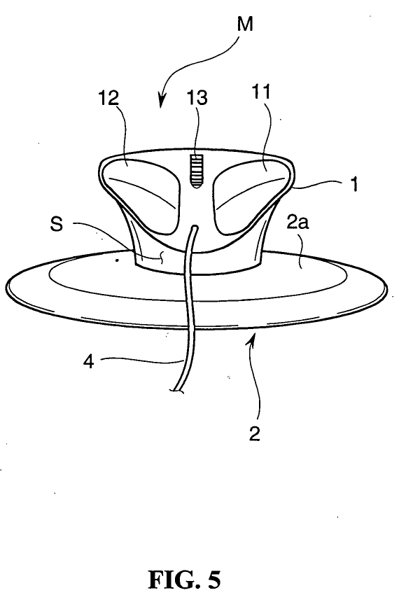

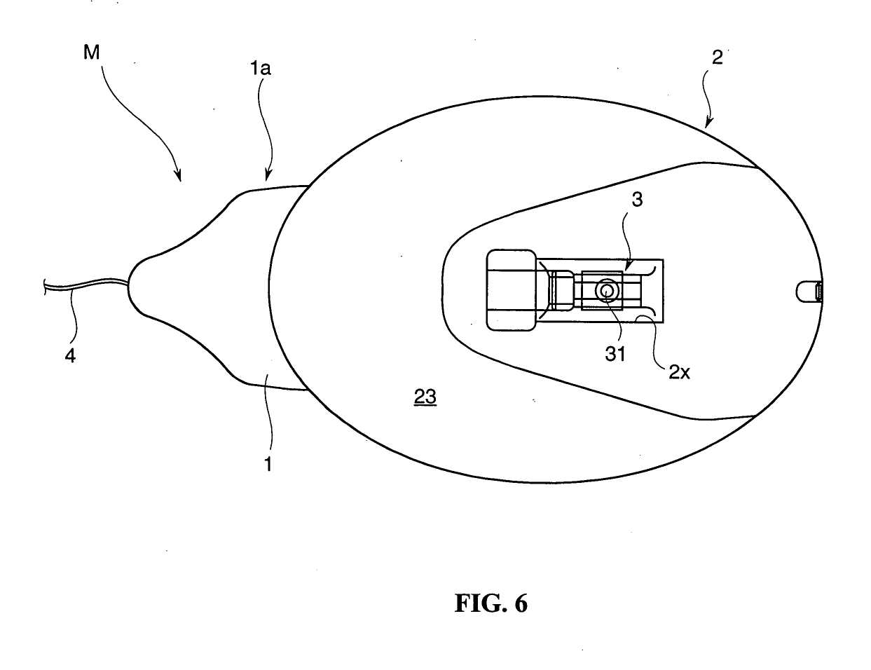

A mouse M in accordance with the embodiment, whose perspective is shown in FIG. 1, whose plane view is shown FIG. 2, whose side view is shown in FIG. 3, whose front view is shown in FIG. 4, whose back view is shown in FIG. 5 and whose bottom view is shown in FIG. 6, comprises a body 1 that has buttons 11, 12 as an input operating portion and a wheel 13 at its front portion, a hand placing portion 2 in a shape of a sheet extending back and forth and right and left from a bottom end portion of the body 1, a traveling direction detecting portion 3 that optically scans a traveling direction of the mouse M and a cable 4 to connect the mouse M with an information processing unit, not shown in drawings. The forward here means a direction heading an operator.

More concretely, as shown in FIG. 1, FIG. 2 and FIG. 3, the body 1 is arranged to stand from a general center of the hand placing portion 2 in an elliptical shape of a sheet and a projecting portion 1a is arranged to project forward from an upper portion of the body 1. As shown in FIG. 1, FIG. 2 and FIG. 5, the wheel 13 is arranged at a center of a width direction of the front end portion of the projecting portion 1a and the buttons 11 and 12 are arranged right and left across the wheel 13. The front end portion of the projecting portion 1a is tapered toward the forward. As shown in FIG. 1, FIG. 3 and FIG. 5, a space S is formed under the projecting portion 1a having the buttons 11 and 12 to insert a finger. The buttons 11 and 12 are so arranged to be operated with a finger pushed downward or pulled forward.

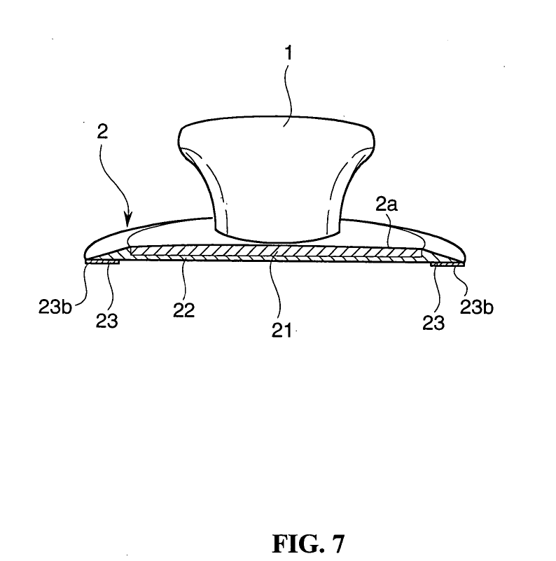

The hand placing portion 2 has, as shown in FIG. 6 and FIG. 7 in which a longitudinally cross-sectional view of a part of the hand placing portion 2 is shown in FIG. 4 is shown, a soft layer 21 made of a soft material, urethane in this embodiment, and a core layer 22 made of a more rigid material. In addition, a hand placing face 2a as a face to be touched by a hand comprises the soft layer 21. The core layer 22 is arranged under the soft layer 21 and at both sides of the soft layer 21. An opening portion 2x that opens downward is arranged at a general center of the hand placing portion 2 and the traveling direction detecting portion 3 is arranged above the opening portion 2x which will be described later. Further, in this embodiment a sliding portion 23 made of a skiddy material, tetrafluoroethylene resin in this embodiment, is arranged under the core layer 22 at the front and both sides of the opening portion 2x. The hand placing portion 2 is used with a bottom surface 23b of the sliding portion 23 placed on an upper surface of a top plate of a desk or the like.

The traveling direction detecting portion 3 comprises, as shown in FIG. 6, a traveling direction detecting portion body 31 arranged above the opening portion 2x of the hand placing portion 2 inside the body 1 and a traveling direction calculating circuit, not shown in drawings, arranged inside the body 1 and in this embodiment the traveling direction detecting portion 3 has the same arrangement as that of a well-known mouse as an optical mouse. More specifically, the traveling direction detecting portion body 31 comprises a CMOS image sensor and it detects an image of the top plate, a traveling direction of the mouse M is calculated by the traveling direction calculating circuit and then the traveling direction of the mouse M is sent to the connected information processing unit, not shown in drawings.

In this embodiment, the mouse M can be moved with keeping the hand put on the hand placing portion 2.

Further, the hand placing portion 2 is so arranged that the operator's wrist, an outer portion of the operator's thumb and an outer portion of the operator's pinkie can be placed on a shaded portion of the hand placing face 2a shown in FIG. 2. More concretely, the hand placing portion 2 comprises a wrist placing area 2a1 which is set at a front area of the hand placing face 2a and on which the wrist is placed and a finger placing area 2a2 on which fingers are placed. Further, the finger placing area 2a2 comprises a first finger placing area 2a3 which is set at a side end portion of the hand placing face 2a and on which the outer portion of the operator's thumb is placed and a second finger placing area 2a4 which is set at other side end area of the hand placing face 2a and on which the outer portion of the operator's pinkie is placed. The shaded portion in FIG. 2 corresponds to a case in which the mouse M is operated with a right hand. However, since the mouse M of this embodiment is symmetry, the wrist, the outer portion of the thumb and the outer portion of the pinkie of a left hand can be put on the hand placing face 2a, which makes it possible to deal with a left-handed person. In this case, the first finger placing area 2a2 and the second finger placing area 2a3 are horizontally flipped. Further, in this embodiment the hand placing portion 2 is flexible.

The mouse M can be moved by hanging an index finger and a middle finger on the buttons 11, 12 and moving the hand horizontally with keeping the wrist put on the hand placing portion 2.

In accordance with the arrangement, there is no chance of rubbing the hand against the top plate, thereby to prevent getting callused due to a long-term operation of the mouse M.

In addition, since the body 1 is arranged to stand from the sheet-shaped hand placing portion 2, an arrangement of the hand placing portion 2 can be simplified.

Further, since the hand placing portion 2 is made of the soft material, the hand placing portion 2 transforms itself by following a posture of the operator handling the mouse M and supports the hand with the hand placing face 2a irrespective of a posture of the operator handling the mouse M, which makes the mouse M user-friendly and soft to the touch. The hand placing portion 2 absorbs a load on the wrist, thereby to effectively prevent tendovaginitis. Since the finger placing area 2a2 is arranged on the hand placing face 2a, the mouse M can be moved without gripping the mouse M by making use of frictional force between the finger placing area 2a2 and a finger of the operator.

In addition, since the hand placing portion 2 is flexible, it is possible to use the mouse M in a stable condition with a part of the hand floating from the hand placing portion 2. Further, if the sliding portion 23 is arranged generally across the hand placing portion 2 except for the traveling direction detecting portion 3, it is possible to move the mouse M smoothly in any state of use.

In addition, since the sliding portion 23 made of tetrafluoroethylene resin is arranged around the traveling direction detecting portion 3, it is possible to move the mouse M smoothly on the top plate without laying any unnecessary stress on the wrist.

Since the projecting portion 1a of the body 1 is tapered toward the forward and the buttons 11, 12 and the wheel 13 are arranged at the front, it is possible to operate the buttons 11, 12 and the wheel 13 with positioning the finger at a desired position.

Since the space S is formed to insert a finger between the projecting portion 1a and the hand placing portion 2, it is possible to operate the mouse M comfortably regardless of a size of the hand.

In addition, since the buttons 11, 12 can be operated by pulling the finger, it is possible to operate the mouse M with ease in a state the finger is inserted into the space S.

The present claimed invention is not limited to the above-described embodiments.

For example, a shape of the body may have the same shape of a conventional mouse and a hand placing portion is arranged under the mouse. With this arrangement, it is possible to prevent the hand from rubbing against the top plate. Further, even though a space is not arranged under the button, it is possible to put the finger on the button without stretching the finger by force as far as a shape of the body is tapered toward the forward. In addition, even though a shape of the body is not tapered, it is possible to operate the mouse M comfortably irrespective of a size of the hand as far as a pace is arranged under the button.

The hand placing portion may not be in a shape of a sheet. For example, it may be formed in a shape of a plate. Or a dent is arranged on a mouse to place a hand on so that an inner side of the dent constitutes the body and the dent constitutes the hand placing portion.

Further, the input operating portion is not necessarily arranged at a front portion of the body. For example, a button may be arranged at both sides of the body.

In addition, the traveling direction detecting portion may have the same arrangement as that of a well-known traveling direction detecting portion as a ball-type mouse.

Other component may be variously modified without departing from the spirit of the invention.

1. A mouse that is used as a pointing device for an information processing unit such as a personal computer and characterized by comprising a body having at least an input operating portion, a traveling direction detecting portion that detects a direction of traveling and a hand placing portion on which an operator can put his or her hand wherein the operator can move the mouse with keeping the hand put on the hand placing portion.

2. The mouse described in claim 1 and characterized by that the hand placing portion is in a shape of a sheet.

3. The mouse described in claim 1, and characterized by that the hand placing portion is so arranged that at least a hand placing face as a face which the hand touches is made of a soft material.

4. The mouse described in claim 1, and characterized by that a front end portion of the body is in a tapered shape toward the forward.

5. The mouse described in claim 1, and characterized by that the input operating portion comprises a button and a space into which the operator can insert his or her finger is arranged under a front portion of the body.

6. The mouse described in claim 5, and characterized by that the button can be pushed with a pulling movement of the finger.

7. The mouse described in claim 5, and characterized by that the body is arranged to stand from the hand placing portion and a projecting portion is arranged to project forward on an upper portion of the body, the button is arranged at a distal end portion of the projecting portion and the space is arranged under the projecting portion.

8. The mouse described in claim 1, and characterized by that a sliding portion made of a skiddy material is arranged to surround the traveling direction detecting portion.

9. The mouse described in claim 2, and characterized by that the hand placing portion is so arranged that at least a hand placing face as a face which the hand touches is made of a soft material.

10. The mouse described in claim 2, and characterized by that a front end portion of the body is in a tapered shape toward the forward.

11 The mouse described in claim 2, and characterized by that the input operating portion comprises a button and a space into which the operator can insert his or her finger is arranged under a front portion of the body.

12. The mouse described in claim 11, and characterized by that the button can be pushed with a pulling movement of the finger.

13. The mouse described in claim 12, and characterized by that the body is arranged to stand from the hand placing portion and a projecting portion is arranged to project forward on an upper portion of the body, the button is arranged at a distal end portion of the projecting portion and the space is arranged under the projecting portion.

14. The mouse described in claim 2, and characterized by that a sliding portion made of a skiddy material is arranged to surround the traveling direction detecting portion.

15. The mouse described in claim 6, and characterized by that the body is arranged to stand from the hand placing portion and a projecting portion is arranged to project forward on an upper portion of the body, the button is arranged at a distal end portion of the projecting portion and the space is arranged under the projecting portion.
